(19) United States
(12) Patent Application Publication
(10) Pub. No.: US 2014/0324686 A1
(43) Pub. Date: Oct. 30, 2014

(54) Computer Implemented System for Management and Optimization of Financial Accounts and Financial Obligations of a User

(71) Applicant: Mohan Dewan, Pune (IN)

(72) Inventor: Mohan Dewan, Pune (IN)

(21) Appl. No.: 14/356,940

(22) PCT Filed: Nov. 5, 2012
(86) PCT No.: PCT/IN2012/000724

§ 371 Date: May 8, 2014

(30) Foreign Application Priority Data
Nov. 8, 2011 (IN) 3143/MUM/2011

(51) Int. Cl. G06Q 20/10

(52) U.S. Cl. CPC G06Q 20/102
USPC 705/39

(57) ABSTRACT

The present disclosure envisages a system that assists a user in efficiently managing a plurality of financial accounts and financial obligations. The system acts as a gateway for accessing all the finance related information of the user. A′ database of the system stores all the information including the number of accounts held by the user along with the corresponding account numbers and the balance available in each of the accounts. The second vertical of the database stores information corresponding to all the financial obligations to be met by the user. The third vertical of the database stores information corresponding to the financial organizations handling the financial accounts associated with the user. The transactions performed towards the fulfillment of financial obligation(s) of the user are stored along with time stamps in chronological order or in the order of importance.

### FIELD OF DISCLOSURE

The present disclosure relates to the field of finance management. Particularly, the present disclosure relates to the field of managing financial accounts and financial obligations.

### BACKGROUND

People use multiple financial accounts to manage their day to day activities and commitments. These financial accounts comprise various bank accounts including savings account, current account, fixed deposit account [FD] and recurring deposit account [RD]. Further, financial accounts are also linked with debit cards and credit cards issued and managed by banks. Further, life insurance policies, National Savings Certificates (NSC) also form a part of the financial assets. A person may have financial accounts associated with and managed by multiple banks. These financial accounts are the financial streams through which money flows in and out. Many banks offer credit cards for the convenience of their customers. These credit cards act like plastic money and do not warrant the user to carry hard cash. The owner of the credit card is billed periodically. Failure to pay the bill to the bank within specified date attracts penal interest. The penal interest levied on the late payment of credit card billing varies from one bank to another.

Different banks have different terms and conditions for the maintenance of financial accounts. These terms and conditions vary with the nature of financial accounts. The minimum balance to be maintained in a financial account varies from one bank to another. Many banks have their own debit and credit policies and the interest paid on deposit varies from one bank to another. The money that has been utilized to maintain the minimum balance in a bank account is static in the sense that it cannot be further utilized to meet any financial obligations.

Financial obligations include various payments to be made by a person towards life insurance premium, vehicle insurance premium, health insurance premium, house rent and the like. The financial obligations further include payments towards electricity bill, telephone bill, water bill, cooking gas bill, bill towards the maintenance charge of the apartment, cell phone bill and equated monthly installments [EMIs] towards housing loan, personal loan, vehicle loan and education loan. The obligations which are not met on or before the due date attract a penalty.

A person typically has multiple financial obligations including but not restricted to life insurance premium, vehicle insurance premium, health insurance premium, house rent. The financial obligations can also include payments towards electricity bill, telephone bill, water bill, cooking gas bill, bill towards the maintenance charge of the apartment, cell phone bill and equated monthly installments [EMIs] towards housing loan, personal loan, vehicle loan and education loan. A person having multiple financial obligations may find it difficult to remember the due dates within which the payments have to be made. Further, a person having multiple financial accounts like various bank accounts, insurance policies may not be able to remember the balance available in each of his or her financial accounts. Still further, the user may not know which financial instrument is to be used to fulfill a particular financial obligation.

United States Patent Application No. 20030144938 discloses a method and system for cash maximization. The customer's financial data is transferred to a vendor and is prepared for processing by an optimization engine and resulting recommendations are sent to the customer. The optimization software uses a series of algorithms to determine the values of the variables that minimize or maximize the objective function. However, this Patent Application does not disclose optimizing multiple financial accounts and financial obligations of a user.

U.S. Pat. No. 4,953,085 discloses a method and apparatus for an improved personal financial management program incorporating means of implementing, coordinating, supervising, analyzing and reporting upon investments in an array of assets and credit facilities. A mathematical programming function is used for suggesting clients about investments and credit facilities to best realize their financial objectives. However, this Patent does not disclose any information corresponding to optimizing multiple financial accounts and financial obligations of a user.

Therefore there is strong felt a need for a system that:
stores information corresponding to various financial accounts and financial obligations associated with a user;
tracks various financial obligations and financial accounts associated with a user;
tracks the due date of payments corresponding to various financial obligations associated with a user;
generates a notification to the user corresponding to the due date of payments of various financial obligations associated with a user;
selects an optimal financial instrument for payments corresponding to various financial obligations associated with a user;
updates the user with information corresponding to fulfillment of financial obligations.

### Objects

Some of the objects of the present disclosure are described herein below:

It is an object of the present disclosure to ameliorate one or more problems of the prior art or to at least provide a useful alternative.

An object of the present disclosure is to provide a system that stores information about various financial accounts and financial obligations associated with a user.

One more object of the present disclosure is to provide a system that tracks the various financial accounts associated with a user.

Further object of the present disclosure is to provide a system that tracks the due date for payments corresponding to various financial obligations of associated with a user.

Still a further object of the present disclosure is to provide a system that generates an alert to notify the user about due dates of various financial obligations associated with a user.

Another object of the present disclosure is to provide a system that selects an optimal financial instrument for payments corresponding to various financial obligations associated with a user.

Yet another object of the present disclosure is to provide a system that generates a notification to inform the user corresponding to fulfillment of financial obligations.

An additional object of the present disclosure is to provide a system that periodically updates a user with information corresponding to fulfillment of financial obligations.

Other objects and advantages of the present invention will be more apparent from the following description when read in conjunction with the accompanying figures, which are not intended to limit the scope of the present invention.

### SUMMARY

The present disclosure envisages a computer implemented system for managing financial accounts and financial obligations of a user. The system, in accordance with the present disclosure includes:
a user interface configured to enable a user to input the information corresponding to the financial accounts associated with the user, the user interface still further configured to enable the user to input the information corresponding to the financial obligations of the user;
a database cooperating with the user interface, the database partitioned into discrete verticals, the database comprising:
   a first vertical configured to store the information corresponding to the financial accounts associated with the user;
   a second vertical configured to store the information corresponding to the financial obligations of the user;
   a third vertical configured to store the information corresponding to at least the terms and conditions under which each of the financial accounts of the user are operated; and
   a fourth vertical configured to store the information corresponding to at least the terms and conditions under which each of the financial' obligations of the user are to be met;
a calculator module having access to the financial accounts of the user, the calculator module configured to automatically calculate the amount of money to be transferred from a financial account of the user to another financial account of the user, in the event that the other financial account is governed by at least favorable terms and conditions of operation;
a transfer module configured to transfer the amount of money calculated by the calculator module from a financial account of the user to the other financial account of the user;
a first tracking module cooperating with the database and configured to configured to track the date(s) and time on which the user is to meet his/her financial obligations;
a second tracking module having access to the financial accounts of the user, the second tracking module configured to track the amount of money available in each of the financial accounts associated with the user;
a determining module having access to the financial accounts of the user, the determining module configured to determine the amount of money to be debited from at least one financial account of the user for fulfilling at least one of the financial obligations of the user, the determining module further configured to identify a financial account of the user having enough money to fulfill at least one financial obligation of the user; and
a triggering module having access to the financial accounts of the user, the triggering module configured to automatically trigger the transfer of determined amount of money from the identified financial account, on or before the due date, for fulfilling the financial obligation(s) of the user.

In accordance with the present disclosure, the user interface is configured to enable the user to input the information corresponding to the financial accounts, wherein the information includes at least financial account numbers, financial account types and names of financial institutions handling the financial accounts of the user.

In accordance with the present disclosure, the user interface is configured to enable the user to input the information corresponding to the financial obligations, wherein the information is selected from the group consisting of at least amount of money to be paid towards meeting the financial obligation and the due date on which the financial obligation has to be fulfilled.

In accordance with the present disclosure, the first vertical stores the information selected from the group consisting of at least financial account numbers, financial account types and names of financial institutions handling the financial accounts.

In accordance with the present disclosure, the second vertical stores the information selected from the group consisting of at least the amount of money to be paid towards meeting the financial obligation and the date on which the financial obligation has to be fulfilled.

In accordance with the present disclosure, the system further includes an alert generation module cooperating with the first tracking module and configured to generate an alert denoting the days on/before which the user is required to fulfill his/her respective financial obligations.

In accordance with the present disclosure, the calculator module is configured to calculate the amount of money to be transferred from a financial account of the user to another financial account of the user depending upon at least one of financial obligations to be met by the user, money available in the financial account(s) of the user.

In accordance with the present disclosure, the transfer module is further configured to generate and transmit a notification to the user indicating the transfer of money from one financial account of the user to the other financial account of the user.

In accordance with the present disclosure, the triggering module is configured to generate a notification subsequent to the automatic transfer of money from the financial account of the user for meeting at least one financial obligation of the user.

The present disclosure envisages a computer implemented method for managing financial accounts and financial obligations of a user. The method, in accordance with the present disclosure includes the following computer implemented steps:
enabling a user to input the information corresponding to the financial accounts associated with the user;
enabling the user to input the information corresponding to the financial obligations of the user;
partitioning a database into discrete verticals including a first vertical, second vertical, a third vertical and a fourth vertical;
storing in the first vertical, the information corresponding to the financial accounts associated with the user;
storing in the second vertical, the information corresponding to the financial obligations associated with, the user;
storing in the third vertical, the information corresponding to at least the terms and conditions under which each of the financial accounts of the user are operated;
storing in the fourth vertical, the information corresponding to at least the terms and conditions under which the financial obligations of the user are to be met;
automatically calculating the amount of money to be transferred from one financial account of the user to another financial account of the user in the event that the other account has favorable terms and conditions of operations;
transferring the calculated amount of money to the other account of the user having favorable terms and conditions;
tracking the date(s) and time on which the user is required to meet his/her financial obligations;
tracking the amount of money available in each of the financial accounts associated with the user;
determining the amount of money to be debited from the financial account(s) of the user for fulfilling the financial obligation(s) of the user;
identifying financial account(s) of the user having enough money to fulfill the financial obligation(s) of the user; and
automatically triggering the transfer of determined amount of money from the identified financial account on or before the due date for fulfilling the financial obligation(s) of the user.

In accordance with the present disclosure, the step of enabling the user to input the information corresponding to the financial accounts further includes the step of enabling the user to input at least financial account numbers, financial account types and names of the financial institutions handling the financial accounts of the user.

In accordance with the present disclosure, the step of enabling the user to input the information corresponding to the financial obligations further includes the step of enabling the user to input the information corresponding to at least amount of money to be paid towards meeting the financial obligation and the due date on which the financial obligation has to be fulfilled.

In accordance with the present disclosure, the step of automatically calculating the amount of money to be transferred from one financial account of the user to another financial account of the user further includes the step of calculating the money to be transferred, depending upon at least one of financial obligations to be met by the user and money available in the financial account(s) of the user.

In accordance with the present disclosure, the method further includes the step of transferring the calculated amount of money to the other account of the user having favorable terms and conditions further includes the step of notifying the user about the transfer of money.

### BRIEF DESCRIPTION OF THE ACCOMPANYING DRAWINGS

The computer implemented system for management and optimization of financial accounts and financial obligations of a user will now be described with reference to the accompanying, non-limiting drawings in which:

FIG. 1 illustrates a schematic of a system for managing financial accounts and financial obligations of a user; and

FIG. 2 and FIG. 3 include a flowchart illustrating the steps involved in the method for managing financial accounts and financial obligations of a user.

### DETAILED DESCRIPTION OF THE ACCOMPANYING DRAWINGS

The system of the present disclosure will now be described with reference to the embodiments shown in the accompanying drawings. The embodiments do not limit the scope and ambit of the disclosure. The description relates purely to the examples and preferred embodiments of the disclosed method and its suggested applications.

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The system and method for managing financial accounts and financial obligations of a user will now be described with reference to the accompanying drawings which do not limit the scope of the disclosure. The description is provided purely by the way of illustration and example.

The present disclosure envisages a system that assists a user in efficiently managing a plurality of financial accounts. Further the system also assists the user in effectively managing and fulfilling a plurality of financial obligations using his/her financial accounts. Nowadays one user/person is typically associated with more than one financial account. Further, it is also typical that a person has more than one financial obligation. The presence of a plurality of financial accounts and a plurality of financial obligations makes it difficult for a person to make a choice between the financial accounts to be used for fulfilling the financial obligations. Moreover, presence of multiple financial accounts also makes it difficult for a person to keep track of all of them. Therefore, to mitigate the aforementioned issues and also the issues elaborated in the background, the present disclosure envisages a system and method for managing a plurality of financial obligations and financial accounts.

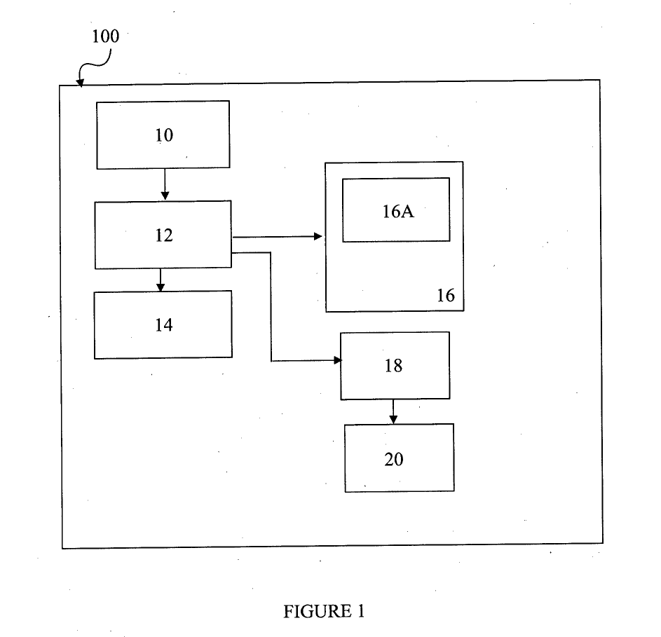

Referring to FIG. 1, there is shown a system 100 for managing financial obligations and financial accounts of a user. The system 100 includes a user authentication module (not shown in figures) configured to authenticate a user using the username and password, designated to the user typically at the time of registration with the system 100. It is only after successful authentication that the user is allowed to access the system 100 and make use of the features and facilities provided by the system 100.

In accordance with the present disclosure the system 100 includes a user interface 10 configured to enable a user to input information corresponding to the financial accounts associated with the user. The information corresponding to the financial accounts of the user includes but is not restricted to financial account numbers, financial account types (savings account/current account/RD Account/FD Account and the like) and the names of the financial institutions handling the financial accounts of the user. The user interface 10 displays a plurality of fields in which the user is required to enter the aforementioned information.

In accordance with the present disclosure the user interface 10 further enables the user to input information about the financial obligations associated with the user. The financial obligations of the user include but are not restricted to payment of life insurance premium, vehicle insurance premium, house rent, electricity bill, water bill, cooking gas bill, cell phone bill, EMI towards housing loan, EMI towards car loan, EMI towards home loan and EMI towards education loan. The user interface 10 enables the user to enter the names of financial obligations along with the amount of money to be debited from the financial accounts of the user (preferably every month) towards fulfilling the aforementioned financial obligations.

The user is required to enter the dates on which the money is to be debited from his/her financial accounts towards fulfillment of the financial obligations. The financial obligations such as life insurance premium, vehicle insurance premium, electricity bill, water bill, cooking gas bill, cell phone bill, EMI towards housing loan, EMI towards car loan, EMI towards home loan and EMI towards education loan also have respective financial accounts associated with them, to which the money is to be credited (preferably every month) to consider the financial obligation to be fulfilled.

In accordance with the present disclosure, the system 100 includes a database 12 cooperating with the user interface 10. The database 12 has been partitioned into discrete verticals. The discrete verticals of the database 12 store the information entered by the user through the user interface. A first vertical of the database 12 is configured to store the information corresponding to the financial accounts held/owned by the user. The financial accounts owned by the user include but are not restricted to saving account, current account, recurring deposit account and fixed deposit account. The information stored in the first vertical further includes account numbers, the amount of money available in each of the financial accounts associated with the user and the names of the financial institutions handling the financial accounts. It is to be noted that the aforementioned account names & types are used only for the purpose of exemplification and that it is possible to implement the system of the present disclosure on other type of accounts as well.

A second vertical of the database 12 stores the information corresponding to the financial obligations to be fulfilled by the user. The information stored in the third vertical includes names of the financial obligations such as life insurance premium, vehicle insurance premium, house rent, electricity bill, water bill, cooking gas bill, cell phone bill, EMI towards housing loan, EMI towards car loan, EMI towards home loan and EMI towards education loan, along with the dates (due dates) on which each of the financial obligations are to be fulfilled. The information in the third vertical also includes the amount of money that needs to be paid (preferably every month, before the due date) in order to fulfill the (aforementioned) financial obligations.

A third vertical of the database 12 stores the information corresponding to the plurality of financial institutions that manage the financial accounts (aforementioned) associated with the user. The information about the financial institutions includes at least names of the financial institutions handling the financial accounts of the user and their respective terms and conditions.

The system 100 further includes a calculator 14 having access to the financial accounts associated with the user. For example if a user has four accounts, namely a savings account in Bank ‘A’, a current account in bank ‘B’ and a recurring deposits account in Bank ‘C’, the calculator 14 is provided with access to all the three accounts. The calculator 14 calculates the amount of money present in all the three accounts, namely the savings account, current account and recurring deposit account. The calculator also determines, from the user input, the amount of money to be credited to the recurring deposit account which is considered to be a financial obligation on the part of the user. The calculator 14 continuously monitors the inflow and outflow of the money into/from the savings account and current account. When for example, a sum of 50000 INR is deposited into the current account of the user, the calculator 14 immediately transfers, for example 45000 INR into the savings account since a savings account provides better interest on the money deposited in the savings account (the terms and conditions of operation of savings account are more favorable than that of the current account). The calculator leaves 5000 INR in the current account since that is the minimum amount needed to be present in the current account to keep the account operational. The data about the minimum balance of the current account is provided to the calculator from the third vertical of the database 12 which stores the terms and conditions for operation of every financial account associated with the user. The calculator 14 cooperates with a transfer module 14A which transfers the calculated amount of money, in this case 45000 INR from the current account of the user to the savings account of the user.

The system 100 in accordance with the present disclosure includes a first tracking module 16 cooperating with the database 12. The first tracking module 16 is configured to access the database 12 to keep a track on the date(s) and time, typically dates of a month, on or before which the user is to pay the stipulated amount of money in order to fulfill his/her financial obligations. The first tracking module cooperates with the database 12, especially the forth vertical of the database 12 to obtain the terms and conditions (including the amount of money to be paid, the penalty if money is not paid in time as installment and the like) under which the financial obligations of the user are to be met.

The system 100 further includes a second tracking module 16A that tracks the amount of money available in each of the accounts, typically the savings account and the current account. The tracking by the second tracking module 16A takes place preferably when the due date for fulfilling the financial obligation(s) is close by. Alternatively, the tracking can take place any time before the due date or on the day on which the payment towards a financial obligation is due (on the due date). The second tracking module 16A determines the amount of money available for utilization in each of the financial accounts associated with the user, in particular the savings account and the current account of the user. The savings account and the current account are concentrated upon because they are the two accounts using which the user can pay money towards his/her financial obligations.

The second tracking module 16A also tracks the amount of money to be retained in each of the financial accounts, in particular the savings accounts and current account, associated with the user. For example, in case of a savings account/current account, the second tracking module 16A will track the minimum amount of money to be retained in the account as minimum balance as per the terms and conditions of the corresponding financial institution. For accomplishing the tracking of minimum balance to be retained in an account, the second tracking module 16B cooperates with the database 12, specifically third vertical of the database 12 which stores the terms and conditions for operation of financial accounts associated with the user.

The system 100 further includes a determining module 18 which is configured to determine the amount of money to be debited from a financial account of the user, in order to fulfill the financial obligation(s) of the user on or before the due date. The determining module 18 also identifies at least one account of the user having enough money to meet the terms and conditions put forth by the financial organization (for example, the minimum balance requirement of banks), and also having enough money to meet the financial obligation(s) of the user well on or before the due date. The determining module 18 cooperates with the second tracking module 16A which tracks the minimum amount of money to be retained in each (typically savings account and current account) financial account of the user, to determine the amount of money that needs to be retained in the financial account associated with the user.

The system 100 in accordance with the present disclosure includes a triggering module 20 configured to trigger the transfer of determined amount of money from the identified financial account of the user, on or before the due date, for fulfilling the financial obligation. The money transfer takes place on or before the last day (on or before the due date) of meeting the deadline for fulfilling the financial obligation(s), to ensure optimization of the monetary resources.

In accordance with the present disclosure, the alert generation module (not shown in figures) is configured to generate alerts/notifications corresponding to the financial obligations to be met by the user, in a particular period of time. The alert generation module also generates an alert denoting the amount of money deducted from the selected financial account of the user towards fulfillment of the financial obligation(s). The alert generation module also generates an alert/notification denoting the amount of money remaining in a financial account associated with the, user, after a stipulated amount has been deducted from that account for fulfilling the financial obligation(s) of the user. The alert generation module also generates an alert/notification denoting the amount of money available in each of the financial accounts associated with the user, after a particular financial obligation has been met. The alerts generated by the alert generation module are displayed to the user on a user interface (not shown in figures).

In accordance with the present disclosure, the system 100 further includes a transaction memory unit (not shown in figures) configured to store the information corresponding to the financial obligations met by the user on/before the due date along with the amount of money paid towards fulfillment of financial obligation(s).

The system 100 of the present disclosure acts as a gateway for accessing all the finance related information of the user. The database 12 (first vertical) of the system 100 stores all the information including the number of accounts including savings accounts, current accounts, fixed deposit accounts and recurring deposit accounts held by the user along with the corresponding account numbers and the balance available in each of the accounts. In case of recurring deposit accounts the information about the money to be deposited every month as the installment towards recurring, deposit is also stored in the database. Further the database 10 also stores the maturity dates corresponding to the fixed deposit account and the recurring deposit account. The aforementioned information is stored in the first vertical of the database 10.

Further, the second vertical of the database 12 stores information corresponding to all the financial obligations to be met by the user, preferably in a given month. The information stored in the second vertical includes information about the amount of money to be paid every month towards life insurance premium, vehicle insurance premium, health insurance premium, house rent, electricity bill, telephone bill, water bill, cooking gas bill, cell phone bill and equated monthly installments [EMIs] corresponding to housing loan, personal loan, vehicle loan and education loan. The second vertical also stores the dates on which each of the aforementioned financial obligations are to be fulfilled.

Further, the third vertical of the database 12 stores information corresponding to the financial organizations handling the financial accounts associated with the user. The information stored in the third vertical includes the name of the financial institutions, account numbers (provided by respective financial institutions), the terms and conditions put forth by the financial institutions and the like. All the transactions performed by the system 100 towards the fulfillment of financial obligation(s) of the user are stored along with time stamps in the transaction memory unit. The transactions are typically stored in chronological order or in the order of importance. All the information stored in the database 12 and the transaction memory unit are displayed to the user on the user interface in a pre-determined format, thereby enabling the user to have access to information corresponding to a plurality of financial accounts and financial obligations.

In accordance with an exemplary embodiment of the present disclosure, a user has two accounts, a savings account and a current account, with bank ‘A’ and bank ‘B’ respectively. The user using the user interface 10 inputs the details corresponding to the aforementioned financial accounts. The details entered by the user include the respective account numbers and account types. The details corresponding to the financial accounts are stored in the first vertical of the database 12. The user has certain financial obligations including payment of recurring deposit installment and payment of health insurance premium installment. The details about the financial obligations of the user including the date (date of every month) on which the obligations are to be met and the amount of money to be paid to fulfill the respective obligations. The details about the financial obligations of the user are stored in the second vertical of the database 12. The calculator module 14 accesses the database to identify the financial accounts associated with the user. The calculator module 14 tracks the inflow/outflow to and from each of the financial accounts associated with the user. The calculator module 14 also tracks the amount of money available in each of the financial accounts associated with the user. The calculator module 14 also cooperates with the third vertical of the database 14 to identify the terms and conditions of operation of each of the financial accounts (in this case, savings account and current account) associated with the user. The calculator module 14 after accessing the third vertical of the database 12 determines that the savings account offers more interest on the money accumulated in the account (favorable terms and conditions) in comparison to the current account. The calculator module 14, based on the terms and conditions of operation also determines the amount of money to be retained in each of the accounts (in this case, savings account and current account) as minimum balance.

Since the terms and conditions of the savings account are favorable, whenever certain amount of money is received into the current account, the calculator module automatically calculates the amount of money that can be transferred to the savings account from the current account. For example, if a sum of 50000 INR is received into the current account, the calculator module decides to retain the minimum balance in the current account and transfers the rest of the money to the savings account (since rate of interest in case of savings account is higher than that of the current account).

Simultaneously, the tracking module 16 cooperating with the database 12, specifically with the second vertical of the database 12, tracks the due dates for fulfilling the financial obligations of the user (in this case the obligations are payment of installment towards recurring deposits and installment towards health insurance). The second tracking module 16A accesses the financial accounts associated with the user and tracks the amount of money available in each of the accounts associated with the user. The determining module 18 accesses the database 12, specifically second vertical of the database 12 and determines the amount of money to be debited from the financial account(s) of the user to meet the financial obligation(s) of the user. Further the determining module 18 accesses the financial accounts of the user to identify at least one account from where the money can be debited in order to fulfill the financial obligation(s) of the user. In this case, the financial obligations of the user are payment of installment towards recurring deposits and installment towards health insurance. The determining module 18 also identifies that the savings account has adequate amount of money to pay for the aforementioned installments and that the current account only has the minimum balance. Subsequently the triggering module 20 triggers a transfer of money from the savings account of the user to the recurring deposit account of the user and to the health insurance account of the user respectively, for fulfilling the financial obligations of the user.

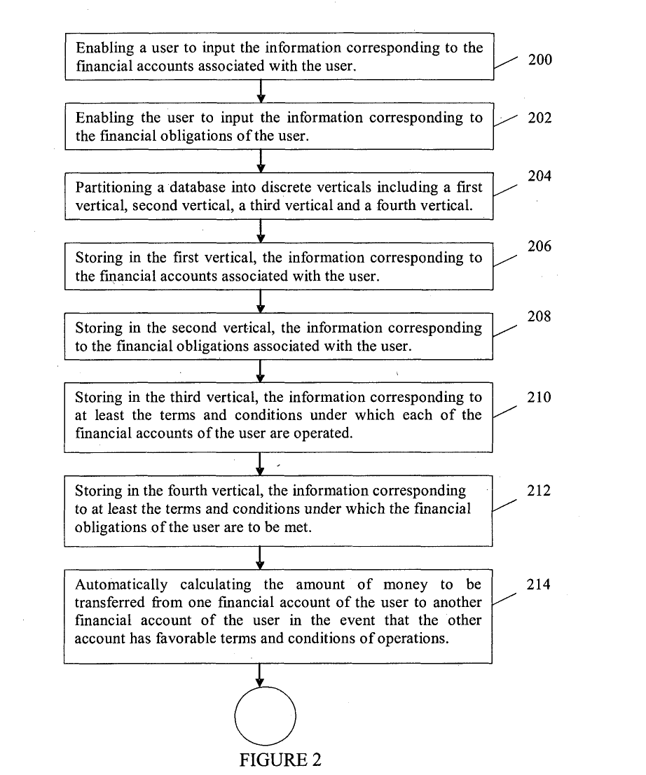

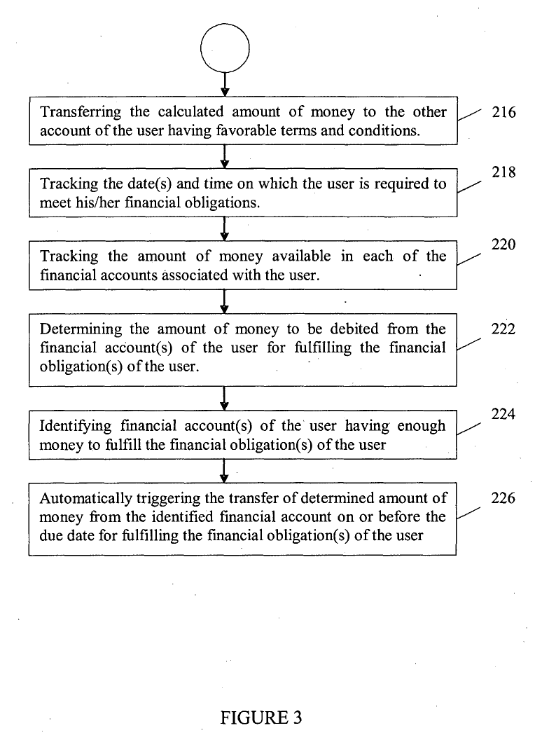

Referring to FIG. 2 and FIG. 3, there is shown a flowchart illustrating the steps involved in the computer implemented method for managing financial accounts and financial obligations of a user. The method, in accordance with the present disclosure includes the following computer implemented steps:
enabling a user to input the information corresponding to the financial accounts associated with the user 200;
enabling the user to input the information corresponding to the financial obligations of the user 202;
partitioning a database into discrete verticals including a first vertical, second vertical, a third vertical and a fourth vertical 204;
storing in the first vertical, the information corresponding to the financial accounts associated with the user 206;
storing in the second vertical, the information corresponding to the financial obligations associated with the user 208;
storing in the third vertical, the information corresponding to at least the terms and conditions under which each of the financial accounts of the user are operated 210;
storing in the fourth vertical, the information corresponding to at least the terms and conditions under which the financial obligations of the user are to be met 212;
automatically calculating the amount of money to be transferred from one financial account of the user to another financial account of the user in the event that the other account has favorable terms and conditions of operations 214;
transferring the calculated amount of money to the other account of the user having favorable terms and conditions 216;
tracking the date(s) and time on which the user is required to meet his/her financial obligations 218;
tracking the amount of money available in each of the financial accounts associated with the user 220;
determining the amount of money to be debited from the financial account(s) of the user for fulfilling the financial obligation(s) of the user 222;
identifying financial account(s) of the user having enough money to fulfill the financial obligation(s) of the user 224; and
automatically triggering the transfer of determined amount of money from the identified financial account on or before the due date for fulfilling the financial obligation(s) of the user 226.

In accordance with the present disclosure, the step of enabling the user to input the information corresponding to the financial accounts further includes the step of enabling the user to input at least financial account numbers, financial account types and names of the financial institutions handling the financial accounts of the user.

In accordance with the present disclosure, the step of enabling the user to input the information corresponding to the financial obligations further includes the step of enabling the user to input the information corresponding to at least amount of money to be paid towards meeting the financial obligation and the due date on which the financial obligation has to be fulfilled.

In accordance with the present disclosure, the step of automatically calculating the amount of money to be transferred from one financial account of the user to another financial account of the user further includes the step of calculating the money to be transferred, depending upon at least one of financial obligations to be met by the user and money available in the financial account(s) of the user.

In accordance with the present disclosure, the method further includes the step of transferring the calculated amount of money to the other account of the user having favorable terms and conditions further includes the step of notifying the user about the transfer of money.

### Technical Advancements

The technical advancements of the system and method envisaged by the present disclosure include the following:
providing a system that stores information on various financial accounts and financial obligations associated with a user;
providing a system that tracks the financial obligations and financial accounts associated with a user;
providing a system that tracks the due date of payments corresponding to various financial obligations associated with a user;
providing a system that selects an optimal financial instrument for the payments corresponding to a plurality of financial obligations associated with a user.
providing a system that updates a user with information corresponding to fulfillment of financial obligations.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the invention to achieve one or more of the desired objects or results.

Any discussion of documents, acts, materials, devices, articles or the like that has been included in this specification is solely for the purpose of providing a context for the invention. It is not to be taken as an admission that any or all of these matters form part of the prior art base or were common general knowledge in the field relevant to the invention as it existed anywhere before the priority date of this application.

The numerical values mentioned for the various physical parameters, dimensions or quantities are only approximations and it is envisaged that the values higher/lower than the numerical values assigned to the parameters, dimensions or quantities fall within the scope of the invention, unless there is a statement in the specification specific to the contrary.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. A computer implemented system for managing financial accounts and financial obligations of a user, said system comprising:
a user interface configured to enable a user to input the information corresponding to the financial accounts associated with said user, said user interface still further configured to enable said user to input the information corresponding to the financial obligations of the user;
a database cooperating with said user interface, said database partitioned into discrete verticals, said database comprising:
a first vertical configured to store the information corresponding to the financial accounts associated with the user;
a second vertical configured to store the information corresponding to the financial obligations of the user; and
a third vertical configured to store the information corresponding to at least the terms and conditions under which each of the financial accounts of the user are operated; and
a fourth vertical configured to store the information corresponding to at least the terms and conditions under which each of the financial obligations of the user are to be met;
a calculator module having access to the financial accounts of the user, said calculator module configured to automatically calculate the amount of money to be transferred from a financial account of the user to another financial account of the user, in the event that the other financial account is governed by at least favorable terms and conditions of operation;
a transfer module configured to transfer the amount of money calculated by the calculator module from a financial account of the user to the other financial account of the user;
a first tracking module cooperating with the database and configured to configured to track the date(s) and time on which the user is to meet his/her financial obligations;
a second tracking module having access to the financial accounts of the user, said second tracking module configured to track the amount of money available in each of the financial accounts associated with the user;
a determining module having access to the financial accounts of the user, said determining module configured to determine the amount of money to be debited from financial account(s) of the user for fulfilling the financial obligation(s) of the user, said determining module further configured to identify financial account(s) of the user having enough money to fulfill the financial obligation(s) of the user; and
a triggering module having access to the financial accounts of the user, said triggering module configured to automatically trigger the transfer of determined amount of money from the identified financial account, on or before the due date, for fulfilling the financial obligation(s) of the user.

2. The system as claimed in claim 1, wherein said user interface is configured to enable the user to input the information corresponding to the financial accounts, wherein said information includes at least financial account numbers, financial account types and names of financial institutions handling the financial accounts of the user.

3. The system as claimed in claim 1, wherein said user interface is configured to enable the user to input the information corresponding to the financial obligations, wherein said information is selected from the group consisting of at least amount of money to be paid towards meeting the financial obligation, the due date on which the financial obligation has to be fulfilled and the terms and conditions under which the financial obligations are to be met.

4. The system as claimed in claim 1, wherein said first vertical stores the information selected from the group consisting of at least financial account numbers, financial account types and names of financial institutions handling the financial accounts.

5. The system as claimed in claim 1, wherein said second vertical stores the information selected from the group consisting of at least the amount of money to be paid towards meeting the financial obligation and the date on which the financial obligation has to be fulfilled.

6. The system as claimed in claim 1, wherein said system further includes an alert generation module cooperating with said first tracking module and configured to generate an alert denoting the days on/before which the user is required to fulfill his/her respective financial obligations.

7. The system as claimed in claim 1, wherein said calculator module is configured to calculate the amount of money to be transferred from a financial account of the user to another financial account of the user depending upon at least one of financial obligations to be met by the user, money available in the financial account(s) of the user.

8. The system as claimed in claim 1, wherein said transfer module is further configured to generate and transmit a notification to the user indicating the transfer of money from one financial account of the user to the other financial account of the user.

9. The system as claimed in claim 1, wherein said triggering module is configured to generate a notification subsequent to the automatic transfer of money from the financial account of the user for meeting at least one financial obligation of the user.

10. A computer implemented method for managing financial accounts and financial obligations of a user, said method comprising the following computer implemented steps:
enabling a user to input the information corresponding to the financial accounts associated with the user;
enabling the user to input the information corresponding to the financial obligations of the user;
partitioning a database into discrete verticals including a first vertical, second vertical, a third vertical and a fourth vertical;
storing in the first vertical, the information corresponding to the financial accounts associated with the user;
storing in the second vertical, the information corresponding to the financial obligations associated with the user;
storing in the third vertical, the information corresponding to at least the terms and conditions under which each of the financial accounts of the user are operated;
storing in the fourth vertical, the information corresponding to at least the terms and conditions under which each of the financial obligations of the user are to be met;
automatically calculating the amount of money to be transferred from one financial account of the user to another financial account of the user in the event that the other account has favorable terms and conditions of operations;
transferring the calculated amount of money to the other account of the user having favorable terms and conditions;
tracking the date(s) and time on which the user is required to meet his/her financial obligations;
tracking the amount of money available in each of the financial accounts associated with the user;
determining the amount of money to be debited from the financial account(s) of the user for fulfilling the financial obligation(s) of the user;
identifying financial account(s) of the user having enough money to fulfill the financial obligation(s) of the user; and
automatically triggering the transfer of determined amount of money from the identified financial account on or before the due date for fulfilling the financial obligation(s) of the user.

11. The method as claimed in claim 10, wherein the step of enabling the user to input the information corresponding to the financial accounts further includes the step of enabling the user to input at least financial account numbers, financial account types and names of the financial institutions handling the financial accounts of the user.

12. The method as claimed in claim 10, wherein the step of enabling the user to input the information corresponding to the financial obligations further includes the step of enabling the user to input the information corresponding to at least amount of money to be paid towards meeting the financial obligation, the due date on which the financial obligation has to be fulfilled and the terms and conditions under which the financial obligations are to be met.

13. The method as claimed in claim 10, wherein the step of automatically calculating the amount of money to be transferred from one financial account of the user to another financial account of the user further includes the step of calculating the money to be transferred, depending upon at least one of financial obligations to be met by the user and money available in the financial account(s) of the user.

14. The method as claimed in claim 10, wherein the method further includes the step of transferring the calculated amount of money to the other account of the user having favorable terms and conditions further includes the step of notifying the user about the transfer of money.
